(19) United States
(12) Patent Application Publication
(10) Pub. No.: US 2015/0017549 A1
(43) Pub. Date: Jan. 15, 2015

(54) ALL-SOLID LITHIUM SECONDARY BATTERY

(71) Applicant: SUMITOMO ELECTRIC INDUSTRIES, LTD., Osaka-shi, Osaka (JP)

(72) Inventors: Junichi Nishimura, Osaka-shi (JP); Kazuhiro Gotou, Itami-shi (JP); Akihisa Hosoe, Osaka-shi (JP); Kentarou Yoshida, Itami-shi (JP)

(21) Appl. No.: 14/382,782

(22) PCT Filed: Feb. 22, 2013
(86) PCT No.: PCT/JP2013/054537

§ 371 Date: Sep. 4, 2014

(30) Foreign Application Priority Data
Mar. 22, 2012 (JP) 2012-064986

(51) Int. Cl. H01M 4/66; H01M 10/0525; H01M 4/38; H01M 4/505; H01M 4/583; H01M 4/485; H01M 10/0562; H01M 4/525

(52) U.S. Cl. CPC H01M 4/662; H01M 10/0562; H01M 10/0525; H01M 4/525; H01M 4/505; H01M 4/583; H01M 4/485; H01M 4/38; H01M 2300/0068; H01M 2220/20; H01M 2220/30
USPC 429/322; 429/245; 429/231.3; 429/223; 429/224; 429/231.8; 429/231.1; 429/231.95; 429/231.6

(57) ABSTRACT

Provided an all-solid lithium secondary battery hardly gives rise to internal resistance even if charging and discharging are repeated. The all-solid lithium secondary battery including a positive electrode and a negative electrode, each of electrodes being an electrode in which a three-dimensional network porous body is used as a current collector and pores of the three-dimensional network porous body are filled with at least an active material, wherein the three-dimensional network porous body of the positive electrode includes an aluminum alloy with a Young's modulus of 70 GPa or higher and the three-dimensional network porous body of the negative electrode includes a copper alloy with a Young's modulus of 120 GPa or higher.

### TECHNICAL FIELD

The present invention relates to an all-solid lithium secondary battery in which a three-dimensional network metal porous body is used.

### BACKGROUND ART

In recent years, there has been a demand for high energy density in batteries used as an electric power supply for portable electronic equipment such as a mobile phone and a smartphone, and for an electric vehicle, a hybrid electric vehicle or the like which has a motor as a source of driving force.

Research has been conducted in a battery that can obtain high energy density including, for example, secondary battery such as a nonaqueous electrolyte secondary battery having characteristics that a capacity is high. Among such secondary batteries, research has been conducted actively in a lithium secondary battery in every field as a battery that can obtain high energy density, since lithium is a substance that has a small atomic weight and large ionization energy.

At present, as a positive electrode of a lithium secondary battery, an electrode in which a compound such as a lithium metal oxide and a lithium metal phosphate is used, is put into practice or in the process of being commercialized the lithium metal oxide including lithium cobalt oxide, lithium manganese oxide, and lithium nickel oxide, and the lithium metal phosphate including lithium iron phosphate. An alloy electrode and an electrode containing carbon, particularly graphite, as a main component are used as a negative electrode. A nonaqueous electrolytic solution obtained by dissolving a lithium salt in an organic solvent is generally used as an electrolyte. In addition, gel electrolytic solutions and solid electrolytes are also gathering attention.

For the purpose of obtaining a high capacity secondary battery, it is proposed to use a current collector having a three-dimensional network structure as a current collector for a lithium secondary battery.

Since the current collector has a three-dimensional network structure, the surface area in contact with an active material increases. Therefore, according to the current collector, it is possible to reduce internal resistance and improve battery efficiency of the lithium secondary battery. In addition, according to the current collector, it is possible to improve circulation of an electrolytic solution and prevent concentration of current and formation of a Li dendrite which has been conventionally problematic. Therefore, reliability of the battery can be improved. Furthermore, according to current collector, it is possible to suppress heat generation and increase the output of the battery. Additionally, the current collector has concave-convex on the skeleton surface of the current collector. Therefore, the current collector can improve retention of the active material, suppress elimination of the active material, ensure a large specific surface area, improve utilization efficiency of the active material, and provide a battery with higher capacity.

Patent Literature 1 discloses that a valve metal is used as a porous current collector, wherein the valve metal has an oxide coating formed on a surface of any one of simple substances of aluminum, tantalum, niobium, titanium, hafnium, zirconium, zinc, tungsten, bismuth, and antimony, or an alloy or stainless alloy thereof.

Patent Literature 2 discloses that a metal porous body is used as a current collector, wherein the metal porous body is obtained by subjecting a skeleton surface of a synthetic resin having a three-dimensional network structure to a primary conductive treatment by non-electrolytic plating, chemical vapor deposition (CVD), physical vapor deposition (PVD), metal coating, and graphite coating, and further subjecting the skeleton surface to a metallization treatment by electroplating.

It is said that a material of a current collector of a positive electrode for a general-purpose lithium-based secondary battery is preferably aluminum. However, since aluminum has a lower standard electrode potential than hydrogen, water is electrolyzed prior to plating of aluminum in an aqueous solution. Therefore, it is difficult to plate aluminum in an aqueous solution. In contrast, Patent Literature 3 describes that an aluminum porous body obtained by forming an aluminum coating on the surface of polyurethane foam by means of molten salt plating, and then, removing the polyurethane foam is used as a current collector for a battery.

An organic electrolytic solution is used as an electrolytic solution for current lithium-ion secondary batteries. However, although the organic electrolytic solution exhibits high ionic conductivity, the organic electrolytic solution is a flammable liquid. Therefore, installation of a protection circuit for the lithium-ion secondary battery can become necessary when the organic electrolytic solution is used as an electrolytic solution of a battery. In addition, when the organic electrolytic solution is used as the electrolytic solution of the battery, a metal negative electrode becomes passivated through reaction with the organic electrolytic solution, resulting in an increase in impedance. As a result, current becomes concentrated at a portion with low impedance to generate a dendrite. In addition, the dendrites penetrate a separator present between the positive electrode and the negative electrode. Therefore, the dendrite penetrates a separator existing between positive and negative electrodes, Therefore, a case of internal short-circuit of a battery occur easily.

Thus, for the purpose of further improving safety and increasing performance of a lithium ion secondary battery, and solving the above described problems, a lithium-ion secondary battery in which a safer inorganic solid electrolyte is used in place of the organic electrolytic solution is studied. Since the inorganic solid electrolyte is generally nonflammable and has high heat resistance, development of a lithium secondary battery using an inorganic solid electrolyte is desired.

For example, Patent Literature 4 discloses that lithium ion conductive sulfide ceramic is used as an electrolyte of an all-solid battery, wherein lithium ion conductive sulfide ceramic includes Li₂S and P₂S₅ and has the composition of 82.5 to 92.5 of Li2S and 7.5 to 17.5 of P2S5 in terms of % by mole.

Furthermore, Patent Literature 5 discloses that highly ion conductive ionic glass, in which an ionic liquid is introduced into ionic glass represented by the formula MₐX-M_{b}Y (wherein M is an alkali metal atom, X and Y are respectively selected from SO₄, BO₃, PO₄, GeO₄, WO₄, MoO₄, SiO₄, NO₃, BS₃, PS₄, SiS₄, and GeS₄, “a” is a valence of X anion; and “b” is a valence of Y anion), is used as a solid electrolyte.

Furthermore, Patent Literature 6 discloses an all-solid lithium secondary battery including a positive electrode containing as a positive electrode active material, a compound selected from the group consisting of transition metal oxides and transition metal sulfides; a lithium ion conductive glass solid electrolyte containing Li₂S; and a negative electrode containing a metal that forms an alloy with lithium as an active material, wherein at least one of the positive electrode active material and the active material of the negative electrode metal contains lithium.

Furthermore, Patent Literature 7 that an electrode material sheet is used as an electrode material used for an all-solid lithium ion secondary battery, wherein the electrode material sheet is formed by inserting an inorganic solid electrolyte into pores of a porous metal sheet having a three-dimensional network structure, in order to improve the flexibility and mechanical strength of an electrode material layer in an all-solid battery to suppress lack and cracks of the electrode material and peeling of the electrode material from the current collector, and in order to improve the contact property between the current collector and the electrode material as well as the contact property between electrode materials.

In a secondary battery in which a three-dimensional network aluminum porous body is used as a current collector of the positive electrode and a three-dimensional network copper porous body is used as a current collector of the negative electrode, there is a case where the internal resistance rises and the output is lowered as charging and discharging are repeated. In addition, since it is necessary to add, to such a lithium ion secondary battery, a conduction aid together with an active material, in order to reduce internal resistance, a problem arises regarding high cost.

### CITATION LIST

### Patent Literature

Patent Literature 1: Japanese Unexamined Patent Publication No. 2005-78991
Patent Literature 2: Japanese Unexamined Patent Publication No. 7-22021
Patent Literature 3: International Publication No. WO 2011/118460
Patent Literature 4: Japanese Unexamined Patent Publication No. 2001-250580
Patent Literature 5: Japanese Unexamined Patent Publication No. 2006-156083
Patent Literature 6: Japanese Unexamined Patent Publication No. 8-148180
Patent Literature 7: Japanese Unexamined Patent Publication No. 2010-40218

### SUMMARY OF INVENTION

### Technical Problem

An object of the present invention is to provide an all-solid lithium secondary battery having a three-dimensional network porous body as a current collector which hardly gives rise to internal resistance even if charging and discharging are repeated.

### Solution to Problem

As a result of intensive study by the present inventors in order to solve the above-mentioned problems, the present inventors found that the problems can be solved by using a three-dimensional network metal porous body including an aluminum alloy as a current collector of a positive electrode and using a three-dimensional network metal porous body including a copper alloy as a current collector of a negative electrode, in an all-solid lithium secondary battery having a three-dimensional network metal porous body as a current collector. Then, these findings have now led to completion of the present invention.

Thus, the present invention relates to an all-solid lithium secondary battery described below.

(1) An all-solid lithium secondary battery including a positive electrode and a negative electrode, each of the electrodes being an electrode in which a three-dimensional network porous body is as a current collector and pores of the three-dimensional network porous body are filled with at least an active material, wherein the three-dimensional network porous body of the positive electrode includes an aluminum alloy with a Young's modulus of 70 GPa or higher and the three-dimensional network porous body of the negative electrode includes a copper alloy with a Young's modulus of 120 GPa or higher.

(2) The all-solid lithium secondary battery according to (1), wherein the active material of the positive electrode is at least one selected from the group consisting of lithium cobalt oxide (LiCoO₂), lithium nickel oxide (LiNiO₂), lithium cobalt nickel oxide (LiCoₓNi₁₋ₓO₂; 0<x<1), lithium manganese oxide (LiMn₂O₄) and lithium manganese oxide compound (LiM_{y}Mn_{2-y}O₄; M=Cr, Co or Ni, 0<y<1), and wherein the active material of the negative electrode is graphite, lithium titanium oxide (Li₄Ti₅O₁₂), a metal selected from the group consisting of Li, In, Al, Si, Sn, Mg and Ca, or an alloy containing at least one of the metals.

(3) The all-solid lithium secondary battery according to (1) or (2), including the positive electrode, the negative electrode, and a solid electrolyte layer sandwiched between the positive electrode and the negative electrode.

(4) The all-solid lithium secondary battery according to (3), wherein the pores of the three-dimensional network porous body are filled with a solid electrolyte, and each of the solid electrolyte and a solid electrolyte forming the solid electrolyte layer is a sulfide solid electrolyte containing lithium, phosphorus and sulfur as constituent elements.

### Advantageous Effects of Invention

The all-solid lithium secondary battery of the present invention exhibits a high output, and an excellent effect such that the rise in internal resistance is not developed even if charging and discharging are repeated. Thus, the all-solid lithium secondary battery of the present invention exhibits high cycle characteristics, and an effect such that the battery can be produced at low production costs.

### BRIEF DESCRIPTION OF DRAWINGS

FIG. 1 is a schematic view showing the basic configuration of an all-solid secondary battery.

FIG. 2 is a schematic view showing the basic configuration of an all-solid secondary battery.

### DESCRIPTION OF EMBODIMENT

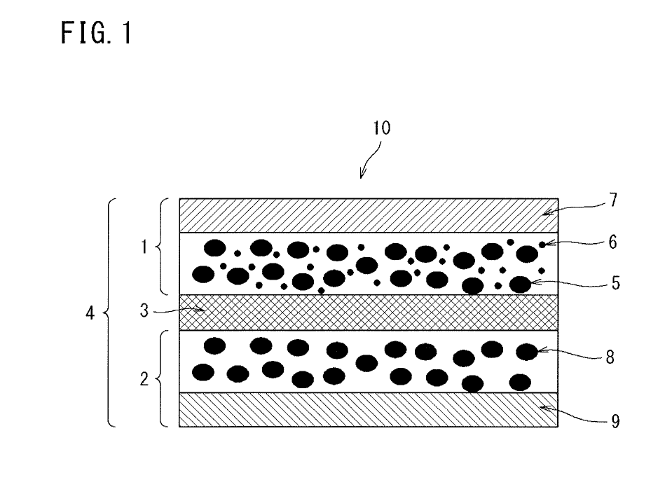

FIG. 1 is a schematic view showing the basic configuration of an all-solid secondary battery. In this connection, in FIG. 1, the all-solid lithium secondary battery will be described as an example of a secondary battery 10. The secondary battery 10 shown in FIG. 1 includes a positive electrode 1, a negative electrode 2, and an ion conductive layer 3 sandwiched between the electrodes 1, 2. In the secondary battery 10, an electrode prepared by mixing positive electrode active material powder 5 such as a lithium-cobalt composite oxide with conductive powder 6 and a binder resin, allowing the mixture to be supported on a current collector 7 of positive electrode and allowing them to be formed into a plate-like shape is used as the positive electrode 1. In addition, an electrode prepared by mixing negative electrode active material powder 8 including a carbon compound with a binder resin, allowing the mixture to be supported on a current collector 9 of negative electrode and allowing them to be formed into a plate-like shape is used as the negative electrode 2. A solid electrolyte is used as the ion conductive layer 3. Although not shown in the figure, the current collector of positive electrode and the current collector of negative electrode are connected to a positive electrode terminal and a negative electrode terminal, respectively, by lead wires.

In the present invention, the positive electrode 1 includes a three-dimensional network metal porous body which is the current collector 7 of positive electrode, the positive electrode active material powder 5 filling pores of the three-dimensional network metal porous body, and a conduction aid which is the conductive powder 6.

In addition, the negative electrode 2 includes a three-dimensional network metal porous body which is the current collector 9 of negative electrode, and the negative electrode active material powder 8 filling pores of the three-dimensional network metal porous body.

In some cases, a conduction aid can be additionally used to fill the pores of the three-dimensional network metal porous body.

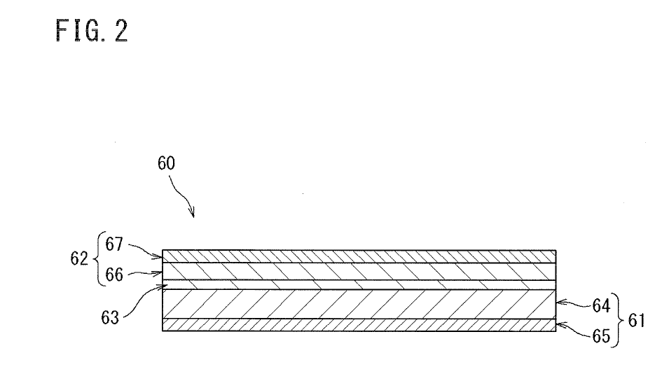

FIG. 2 is a schematic view describing the basic configuration of an all-solid secondary battery. In this connection, in FIG. 2, the all-solid lithium ion secondary battery is exemplified by an all-solid secondary battery and will be described.

An all-solid secondary battery 60 shown in FIG. 2 includes a positive electrode 61, a negative electrode 62, and a solid electrolyte layer (SE layer) 63 sandwiched between the electrodes 61, 62. The positive electrode 61 includes a positive electrode layer (a positive electrode body) 64 and a current collector 65 of positive electrode. In addition, the negative electrode 62 includes a negative electrode layer 66 and a current collector 67 of negative electrode.

In the present invention, the positive electrode 61 includes a three-dimensional network metal porous body which is the current collector 65 of positive electrode, and a lithium ionic conductive solid electrolyte and a positive electrode active material filling pores of the three-dimensional network metal porous body.

In addition, the negative electrode 62 includes a three-dimensional network metal porous body which is the current collector 67 of negative electrode, and a lithium ionic conductive solid electrolyte and a negative electrode active material filling pores of the three-dimensional network metal porous body. In some cases, a conduction aid can be additionally used to fill the pores of the three-dimensional network metal porous body.

(Three-Dimensional Network Metal Porous Body)

With regard to a conventional secondary battery including an aluminum porous body as a current collector for positive electrode and a three-dimensional network copper porous body as a current collector for negative electrode, it has been found that the internal resistance rises when charging and discharging are repeated.

The present inventors have solved the above-mentioned problems by using a three-dimensional network aluminum alloy porous body as a current collector for positive electrode and using a three-dimensional network copper alloy porous body as a current collector for negative electrode.

In a secondary battery, the rise in internal resistance can be prevented by using a three-dimensional network aluminum alloy porous body including an aluminum alloy with a Young's modulus of 70 GPa or higher as a current collector for positive electrode and using a three-dimensional network copper alloy porous body including a copper alloy with a Young's modulus of 120 GPa or higher as a current collector for negative electrode.

Although the detail concerning the reason why the rise in internal resistance can be prevented is unknown, the reason therefor is considered as follows.

As like a conventional all-solid lithium secondary battery, in the case where a three-dimensional network metal porous body including pure aluminum and a three-dimensional network metal porous body including pure copper are used as current collectors, in an early stage of using the battery, since pores of the three-dimensional network metal porous body containing an active material are expanded when the active material is expanded, and the pores of the three-dimensional network metal porous body are contracted when the active material is contracted, the contact state between the skeleton of the three-dimensional network metal porous body and the active material is kept good. However, as the number of times of charging and discharging increases, pores of the three-dimensional network metal porous body are expanded and left standing, and thus are difficult to be contracted. Thus, with regard to the conventional all-solid lithium secondary battery, it is considered that the internal resistance rises since a clearance is generated between the skeleton of the three-dimensional network metal porous body and the active material and the contact state between the three-dimensional network metal porous body and the active material is worse.

On the other hand, as in the present invention, in the case where a three-dimensional network metal porous body including an aluminum alloy with a Young's modulus of 70 GPa or higher and a three-dimensional network metal porous body including a copper alloy with a Young's modulus of 120 GPa or higher are used as current collectors, since the rigidity of the skeleton of each of these porous bodies is higher than the rigidity of the skeleton of a three-dimensional network metal porous body including pure aluminum or pure copper, the pores formed by the skeleton hardly undergo plastic deformation even when the active material is expanded or contracted. Therefore, in the all-solid lithium secondary battery of the present invention, it is considered that the rise in internal resistance can be prevented since the contact state between the skeleton forming pores of the three-dimensional network metal porous body and the active material filling the pores is kept good.

In addition, as in the present invention, in the case where a three-dimensional network aluminum alloy porous body and a three-dimensional network copper alloy porous body are used as current collectors for an all-solid lithium secondary battery, it is considered that the all-solid lithium secondary battery has an advantage such that the contact state between the current collector and the solid electrolyte layer can also be maintained in a good condition.

For example, the three-dimensional network aluminum alloy porous body can be produced by performing the following procedures.

A polyurethane foam having a conductive layer on the surface is used as a workpiece. After the workpiece is set in a jig having an electricity supply function, the jig is placed in a glove box maintaining with an argon atmosphere and a low-moisture condition (dew point of −30° C. or lower), and immersed in a molten salt aluminum plating bath at a temperature of 40° C. The jig holding the workpiece is fitted is connected to the cathode of a rectifier, and a pure aluminum plate is connected to the anode of the rectifier. For example, as the molten salt aluminum plating bath, a plating bath obtained by adding 1,10-phenanthroline to 33 mol % of 1-ethyl-3-methylimidazolium chloride (EMIC)-67 mol % of AlCl₃ is used. Next, the workpiece is plated by passing a direct current at a current density of 3.6 A/dm² between the workpiece and the pure aluminum plate to form an aluminum platting layer on the polyurethane foam surface, thereby giving an aluminum-resin composite porous body. In this plating layer, phenanthroline, which is an organic substance containing carbon, is incorporated. Then, a heat treatment is performed by heating the aluminum-resin composite porous body to 450 to 630° C. in atmosphere, thereby removing the polyurethane foam therefrom and dispersing finely fine Al₄C₃ (nanometer order) in the crystal grain of the aluminum porous body. In this way, a three-dimensional network aluminum alloy porous body in which the Young's modulus is enhanced can be obtained.

In addition, the copper alloy, for example, a copper-nickel alloy, can be produced by performing the following procedures.

A polyurethane foam is used as a workpiece. The workpiece is plated by immersing the workpiece in a copper plating bath to form a copper plating layer on the polyurethane foam surface. Then, the resulting product in which a copper plating layer is formed on the surface of polyurethane foam is plated by immersing the resulting product in a nickel plating bath to form a nickel plating layer on the surface of the copper plating layer. Next, a heat treatment is performed by heating the resulting product to about 600° C. in an air atmosphere to remove the resin, and thereafter a heat treatment is performed by heating the resulting product to about 1000° C. in a hydrogen atmosphere to allow the nickel to be thermally diffused. In this way, a copper-nickel alloy can be obtained. On the surface of polyurethane foam used as a workpiece, a nickel plating layer can be previously formed and then a copper plating layer can be formed.

The Young's modulus of a three-dimensional network metal porous body can be measured by embedding a three-dimensional network metal porous body in a resin, cutting the resultant, grinding and polishing the cutting surface, and pressing an indenting tool of a nanoindenter against a cross section of a skeleton (plated) part.

The nanoindenter is measuring means used for measuring the hardness and Young's modulus in a micro area.

For example, the three-dimensional network metal porous body can be obtained by forming a metal coating with a desired thickness on the surface of a resin porous body having continuous pores (a porous resin molded body) such as polyurethane foam with a use of a method such as a plating method, a vapor deposition method, a sputtering method and a thermal spraying method, and thereafter removing the resin porous body.

—Conductive Treatment (Formation of Conductive Layer)—

Examples of a method of forming a conductive layer on the surface of a resin porous body include a plating method, a vapor deposition method, a sputtering method and a thermal spraying method. Among of them, a plating method is preferred. In this case, first, a conductive layer is formed on the surface of a resin porous body.

Since the conductive layer plays a role in attaining the formation of a metal film (an aluminum plating layer, a copper plating layer, a nickel plating layer and the like) on the surface of a resin porous body by a plating method or the like, the material and thickness thereof are not particularly limited as long as the layer has conductivity. A conductive layer is formed on the surface of a resin porous body by various methods capable of imparting the resin porous body with conductivity. For example, as the method of imparting conductivity, any method such as an electroless plating method, a vapor deposition method, a sputtering method, and a method of applying a conductive paint containing conductive particles such as carbon particles can be used.

It is preferred that the material for a conductive layer be the same material as that for a metal coating.

The non-electrolytic plating method includes a method known in the art such as a method including the steps of rinsing, activating, and plating.

As the sputtering method, various sputtering methods known in the art, for example, a magnetron sputtering method or the like, can be used. When performing the sputtering method, examples of the material used for forming the conductive layer include aluminum, nickel, chromium, copper, molybdenum, tantalum, gold, aluminum-titanium alloys, nickel-iron alloys, and the like. Among those described above, aluminum, nickel, chromium, copper, and alloys of which main component is any of those are suitable from the viewpoint of cost and the like.

In the present invention, the conductive layer can be a layer containing a powder of at least one type selected from the group consisting of graphite, titanium, and stainless steel. Such conductive layer can be formed by, for example, applying a slurry onto the surface of the resin porous body, the slurry being obtained by mixing a powder such as graphite, titanium, and stainless steel with a binder. In this case, since the powder is hardly oxidized in an organic electrolytic solution, since the powder has oxidation resistance and corrosion resistance. The powder can be used alone or in admixture of not less than two kinds. Among these powders, the powder of graphite is preferred. As the binder, for example, polyvinylidene fluoride (PVDF) and polytetrafluoroethylene (PTFE), which are fluorine resins having excellent electrolytic solution resistance and oxidation resistance are suitable. In the all-solid lithium secondary battery of the present invention, since the skeleton of the three-dimensional network metal porous body exists so as to envelope an active material, the content of the binder in the slurry can be about one-half of that in the case where a general-purpose metal foil is used as a current collector, and the content can be set to, for example, about 0.5% by weight.

—Formation of Metal Coating (Aluminum Plating Layer, Copper Plating Layer, Nickel Plating Layer, and the Like)—

A metal coating having a desired thickness is formed by forming thinly a conductive layer on the surface of a resin porous body by the above-mentioned method, and then performing a plating process on the surface of the resin porous body on which the conductive layer has been formed, to give a metal-resin complex porous body.

A coating of an aluminum alloy can be formed by using a method of plating the surface of a resin porous body of which surface has been rendered conductive, in a molten salt bath containing the ingredient of the aluminum alloy in accordance with a method disclosed in WO2011/118460. Thereafter, by removing the resin porous body from the metal-resin porous body complex porous body, the three-dimensional network aluminum alloy porous body is obtained.

A coating of a copper alloy can be formed by using a method of plating the surface of a resin porous body of which surface has been rendered conductive, in an aqueous plating bath containing the ingredient of the copper alloy. Thereafter, by removing the resin porous body from the metal-resin porous body complex porous body, the three-dimensional network copper alloy porous body is obtained.

—Resin Porous Body—

As the material for a resin porous body, a porous body including any synthetic resin can be selected. Examples of the resin porous body include a foamed body of a synthetic resin such as polyurethane, a melamine resin, polypropylene and polyethylene. Since the resin porous body can be a product having continuous pores (interconnected pores), in addition to the foamed body of a synthetic resin, a resin molded body (a resin porous body) with an arbitrary shape can be used. In addition, in place of the foamed body of a synthetic resin, for example, a product having a shape like nonwoven fabric prepared by allowing fibers of a fibrous synthetic resin to be entangled with each other can also be used. The porosity of the resin porous body is preferably 80% to 98%. In addition, the pore diameter of the resin porous body is preferably 50 μm to 500 μm. Among these resin porous bodies, polyurethane foam and a melamine resin foamed body can be preferably used as the resin porous body since they have a high porosity and pores thereof have intercommunicating properties and they are also excellent in pyrolytic property.

In particular, polyurethane foam is preferred in terms of uniformity of pores, easy availability and the like. Nonwoven fabric is preferred in that a three-dimensional network metal porous body with a small pore diameter can be obtained.

Among these resin porous bodies, residues of a foam stabilizer, an unreacted monomer and the like which are used in the production process are frequently contained in a foamed body of a synthetic resin. Therefore, from the viewpoint of smoothly performing a subsequent process, at the time of producing a three-dimensional network metal porous body, it is preferred that the foamed body of a synthetic resin used be previously subjected to a washing treatment. In the resin porous body, the skeleton three-dimensionally constitutes network and totally constitutes continuous pores. The skeleton of polyurethane foam has a nearly triangular shape in the cross section perpendicular to its extending direction. In this context, the porosity is defined by the following equation.

Porosity=(1−(Mass of resin porous body (g)/(Volume of resin porous body (cm³)×Material density)))×100(%)

In addition, with regard to the pore diameter, an average value is determined by taking a photograph or the like of the magnified resin porous body surface through a microscope, counting the number of pores per 1 inch (25.4 mm), and substituting the number into the equation of the average pore diameter=25.4 mm/number of pores.

Although the combination of each of a metal constituting a current collector for positive electrode and a metal constituting a current collector for negative electrode and an active material can be selected from various types of combination, a preferred example can be exemplified by a combination of a positive electrode in which lithium cobalt oxide is used as the positive electrode active material and an aluminum alloy porous body is used as the current collector of positive electrode and a negative electrode in which lithium titanium oxide is used as the negative electrode active material and a copper alloy porous body is used as the current collector of negative electrode.

Following this, the case of a lithium secondary battery will be described as an example of the materials for an active material and a solid electrolyte. In addition, a method of filling a three-dimensional network metal porous body with an active material will be described.

(Positive Electrode Active Material)

A material capable of insertion or desorption of lithium ions can be used as a positive electrode active material.

Examples of the material of the positive electrode active material include lithium cobalt oxide (LiCoO₂), lithium nickel oxide (LiNiO₂), lithium nickel cobalt oxide (LiCoₓNi₁₋ₓO₂; 0<x<1), lithium manganese oxide (LiMn₂O₄), a lithium manganese oxide compound (LiM_{y}Mn_{2-y}O₄; M=Cr, Co, or Ni; 0<y<1). Other examples of the materials for the positive electrode active material include an olivine compound, for example, lithium transition metal oxide such as lithium iron phosphate (LiFePO₄) and LiFe_{0.5}Mn_{0.5}PO₄, or the like.

Other examples of materials of the positive electrode active material include a lithium metal of which skeleton is a chalcogenide or a metal oxide (i.e., a coordination compound including a lithium atom in a crystal of a chalcogenide or a metal oxide). Examples of the chalcogenide include sulfides such as TiS₂, V₂S₃, FeS, FeS₂, and LiMS_{z} (wherein M represents a transition metal element (e.g., Mo, Ti, Cu, Ni, Fe), Sb, Sn, or Pb; and “z” is a numerical number of 1.0 or more and 2.5 or less). Examples of the metal oxide include TiO₂, Cr₃O₈, V₂O₅, MnO₂, and the like.

The positive electrode active material can be used in combination with the conduction aid and the binder. When the material of the positive electrode active material is a compound containing a transition metal atom, the transition metal atom contained in the material can be partially substituted with another transition metal atom. The positive electrode active material can be used alone or in admixture of not less than two kinds. From the viewpoint of efficiently inserting and eliminating a lithium ion, preferred one among the positive electrode active materials is at least one selected from the group consisting of lithium cobalt oxide (LiCoO₂), lithium nickel oxide (LiNiO₂), lithium cobalt nickel oxide (LiCoₓNi₁₋ₓO₂; 0<x<1), lithium manganese oxide (LiMn₂O₄) and a lithium manganese oxide compound (LiM_{y}Mn_{2-y}O₄); M=Cr, Co or Ni, 0<y<1). In addition, lithium titanium oxide (Li₄Ti₅O₁₂) among the materials of the positive electrode active material can also be used as a negative electrode active material.

(Negative Electrode Active Material)

A material capable of insertion or disorption of lithium ions can be used as a negative electrode active material. Examples of the negative electrode active material include graphite, lithium titanium oxide (Li₄Ti₅O₁₂), and the like.

Further, as another negative electrode active material, metals such as metal lithium (Li), metal indium (In), metallic aluminum (Al), metallic silicon (Si), metal tin (Sn), metal magnesium (Mn), and metal calcium (Ca); and an alloy formed by combining at least one of the above-mentioned metals and other elements and/or compounds (i.e., an alloy including at least one of the above-mentioned metals) can be employed.

The negative electrode active material can be used alone or in admixture of not less than two kinds. From the viewpoint of performing efficient insertion and disorption of lithium ions and performing efficient formation of an alloy with lithium, preferred ones among the negative electrode active materials are lithium titanium oxide (Li₄Ti₅O₁₂), or a metal selected from the group consisting of Li, In, Al, Si, Sn, Mg, and Ca, or an alloy including at least one of these metals.

(Solid Electrolyte to Fill the Metal Three-Dimensional Network Porous Body)

As the solid electrolyte for filling pores of the metal three-dimensional network porous body, a sulfide solid electrolyte having high lithium ion conductivity is preferably used. Examples of the sulfide solid electrolyte include a sulfide solid electrolyte containing lithium, phosphorus, and sulfur as constituent elements. The sulfide solid electrolyte can also contain elements such as O, Al, B, Si, and Ge as constituent elements.

Such a sulfide solid electrolyte can be obtained by a known method. Examples of such method include a method of mixing, as starting materials, lithium sulfide (Li₂S) and diphosphorus pentasulfide (P₂S₅) at a mole ratio (Li₂S/P₂S₅) for Li₂S and P₂S₅ of 80/20 to 50/50, and melting and rapidly quenching the resulting mixture (melting and rapid quenching method); a method of mechanically milling the mixture (mechanical milling method), and the like.

The sulfide solid electrolyte obtained by the above-mentioned method is amorphous. In the present invention, for the sulfide solid electrolyte, an amorphous sulfide solid electrolyte can be used, or a crystalline sulfide solid electrolyte obtained by heating the amorphous sulfide solid electrolyte can be used. Improvement of lithium ion conductivity can be expected by crystallization.

(Solid Electrolyte Layer (SE Layer))

The solid electrolyte layer can be obtained by forming the solid electrolyte material in a film-like manner.

The layer thickness of the solid electrolyte layer is preferably 1 μm to 500 μm.

(Conduction Aid)

In the present invention, a conduction aid that is commercially available or known in the art can be used as a conduction aid. The conduction aid is not particularly limited, and examples thereof include carbon black such as acetylene black and Ketjenblack; activated carbon; graphite, and the like. When graphite is used as the conduction aid, the shape thereof can be any of forms such as a spherical form, a flake form, a filament form, and a fibriform such as a carbon nanotube (CNT).

(Slurry of Active Material Etc.)

A slurry is produced by adding the conduction aid and the binder to the active material and the solid electrolyte as occasion demand, and then mixing the resulting mixture with an organic solvent, water, or the like.

The binder can be one commonly used in the positive electrode for a lithium secondary battery. Examples of the material of the binder include fluorine resins such as PVDF and PTFE; polyolefin resins such as polyethylene, polypropylene, and ethylene-propylene copolymers; and thickening agents (e.g., a water-soluble thickener such as carboxymethyl cellulose, xanthan gum, and pectin agarose).

The organic solvent used in preparing the slurry can be an organic solvent which does not adversely affect materials (i.e., an active material, a conduction aid, a binder, and a solid electrolyte as required) to be filled into the metal porous body, and the organic solvent can be appropriately selected from such organic solvents. Examples of the organic solvents include n-hexane, cyclohexane, heptane, toluene, xylene, trimethyl benzene, dimethyl carbonate, diethyl carbonate, ethyl methyl carbonate, propylene carbonate, ethylene carbonate, butylene carbonate, vinylene carbonate, vinyl ethylene carbonate, tetrahydrofuran, 1,4-dioxane, 1,3-dioxolane, ethylene glycol, N-methyl-2-pyrrolidone and the like. When water is used as a solvent, a surfactant can be used for enhancing the filling performance.

The binder can be mixed with a solvent when forming the slurry, or can be dispersed or dissolved in the solvent in advance. For example, a water-based binder such as an aqueous dispersion of a fluorine resin obtained by dispersing the fluorine resin in water, and an aqueous solution of carboxymethyl cellulose; and an NMP solution of PVDF that is usually used when a metal foil is used as the current collector can be used. In the present invention, since the positive electrode active material comes to have a structure of being enveloped by a conductive skeleton by using a three-dimensional porous body as the current collector, a water-based solvent can be used. In addition, the use and reuse of an expensive organic solvent and environmental consideration become unnecessary. Therefore, it is preferred to use a water-based binder containing at least one binder selected from the group consisting of a fluorine resin, a synthetic rubber and a thickening agent, and a water-based solvent.

The contents of each components in the slurry are not particularly limited, and can be appropriately determined in accordance with the binder and solvent and the like, that are to be used.

(Filling Metal Three-Dimensional Network Porous Body with Active Material Etc.)

Filling the pores of the three-dimensional network metal porous body with the active material etc., can be performed by allowing a slurry of the active material etc., to enter the gaps inside the three-dimensional network metal porous body, with a use of a known method such as immersion filling method and a coating method. Examples of the coating method include a roll coating method, an applicator coating method, an electrostatic coating method, a powder coating method, a spraying coating method, a spray-coater coating method, a bar-coater coating method, a roll-coater coating method, a dip-coater coating method, a doctor-blade coating method, a wire-bar coating method, a knife-coater coating method, a blade coating method, a screen printing method, and the like.

The amount of the active material to be filled is not particularly limited, and the amount can be, for example, about 20 to 100 mg/cm², and preferably 30 to 60 mg/cm².

It is preferred that the electrode is pressed in a state in which the slurry is filled into the current collector.

The thickness of the electrode is ordinarily set to about 100 to 450 μm by the pressing step. The thickness of the electrode is preferably 100 to 250 μm in the case of the electrode of a secondary battery for a high output, and is preferably 250 to 450 μm in the case of the electrode of a secondary battery for a high capacity. A pressing step is preferably performed with a use of a roller press machine. Since the roller press machine is the most effective in smoothing an electrode surface, the possibility of short circuiting can be reduced by pressing the electrode with the roller press machine.

As occasion demand, a heat treatment can be performed after the pressing step when producing the electrode. When the heat treatment is performed, the binder is melted to enable the active material to bind to the three-dimensional network metal porous body more firmly. In addition, the active material is calcined to improve the strength of the active material.

The temperature of the heat treatment is equal to or higher than 100° C. or higher, and preferably 150 to 200° C.

The heat treatment can be performed under ordinary pressure or performed under reduced pressure. However, the heat treatment is preferably performed under reduced pressure. When the heat treatment is performed under reduced pressure, the pressure is, for example, 1000 Pa or less, and preferably 1 to 500 Pa.

The heating time is appropriately determined according to the atmosphere of heating, the pressure and the like. The heating time can be usually 1 to 20 hours and preferably 5 to 15 hours.

Moreover, as occasion demand, a drying step can be performed according to an ordinary method between the filling step and the pressing step.

It should be noted that, in an electrode material of a conventional lithium ion secondary battery, the active material is applied on the surface of a metal foil, and the application thickness of the active material is set to be large in order to improve the battery capacity per unit area. In addition, since the metal foil and the active material have to be electrically in contact for effectively utilizing the active material, the active material is mixed with the conduction aid to be used. On the other hand, since the three-dimensional network metal porous body for a current collector of this embodiment has a high degree of porosity and a large surface area size per unit area, a contact area between the current collector and the active material is enlarged. Therefore, the active material can be effectively utilized, thereby improving the capacity of the battery, and reducing the amount of the conduction aid to be mixed.

### EXAMPLES

Hereinafter, the present invention will be described in more detail on the basis of examples. However, these examples are merely illustrative and the present invention is not limited thereto. The present invention includes meaning equivalent to the scope of the claims and all modifications within the scope.

### Production Example 1

### Production of Aluminum Alloy Porous Body 1

(Formation of Conductive Layer)

A polyurethane foam (porosity: 95%, thickness: 1 mm, number of pores per inch: 30 (847 μm in pore diameter)) was used as a resin porous body. A conductive layer was formed on the surface of the polyurethane foam by a sputtering method so that the basis weight of aluminum was 10 g/m².

(Molten Salt Plating)

The polyurethane foam having a conductive layer formed on the surface thereof was used as a workpiece. After the workpiece was loaded to a jig having an electricity supply function, the jig was placed in a glove box which was kept an argon atmosphere and a low moisture condition (dew point of −30° C. or lower), and then immersed in a molten salt aluminum plating bath at a temperature of 40° C. The molten salt aluminum plating bath was a plating bath obtained by adding 1,10-phenanthroline to 33 mol % of EMIC-67 mol % of AlCl₃ so as to have a concentration of 5 g/L. The jig holding the workpiece was connected to the cathode of a rectifier and a pure aluminum plate was connected to the anode of the rectifier. Next, the surface of the workpiece was plated by passing a direct current at a current density of 3.6 A/dm² for 90 minutes between the workpiece and the pure aluminum plate while stirring the molten salt aluminum plating bath, thereby giving an “aluminum-resin composite porous body 1” in which an aluminum plating layer (aluminum weight per unit area: 150 g/m²) was formed on the surface of the polyurethane foam. In the aluminum plating layer, phenanthroline, as an organic substance containing carbon atoms, was incorporated. Stirring of the molten salt aluminum plating bath was performed with a Teflon (registered trademark) rotor and a stirrer. The current density refers to a value calculated from the apparent area of polyurethane foam.

(Decomposition of Polyurethane Foam)

A heat treatment was performed by heating “aluminum-resin composite porous body 1” to 450 to 630° C. in atmosphere. Fine Al₄C₃ (nanometer order) was finely dispersed in the crystal grain of the aluminum porous body, while the polyurethane foam was removed, to give “aluminum alloy porous body”.

The Young's modulus of “aluminum alloy porous body” was determined to be 81 GPa.

### Production Example 2

### Production of Aluminum Porous Body

The same procedure as that in Production Example 1 was performed to give “aluminum porous body” except that a plating bath (composition: 33 mol % EMIC-67 mol % AlCl₃) was used as the molten salt aluminum plating bath in Production Example 1.

The Young's modulus of “aluminum porous body” was determined to be 65 GPa.

### Production Example 3

### Production of Copper Alloy Porous Body 1

A conductive layer was formed on the surface of a polyurethane foam used in Production Example 1 by a sputtering method so that the basis weight of copper was 10 g/m².

Next, the polyurethane foam having a conductive layer formed on the surface thereof was immersed in a copper plating bath. A pure copper plate was used as a counter electrode. Copper plating was performed so that the basis weight of copper was 280 g/m². Then, the resulting product was immersed in a nickel plating bath. A pure nickel plate was used as a counter electrode. Nickel plating was performed so that the basis weight of nickel was 120 g/m². Thereafter, a heat treatment was performed by heating the resulting product to 600° C. in an air atmosphere. The resin was removed from the product. Thereafter, a heat treatment was performed by heating the resulting product to 1000° C. in a hydrogen atmosphere. The nickel was allowed to be thermally diffused to give “copper alloy porous body”.

The Young's modulus of “copper alloy porous body” was determined to be 160 GPa.

### Production Example 4

The same procedure as that in Production Example 3 was performed to give “copper porous body” including pure copper except that copper plating was performed so as to allow the basis weight of copper to be 400 g/m² with a copper plating bath and nickel plating was not performed in Production Example 3.

The Young's modulus of “copper porous body” was determined to be 115 GPa.

The composition of each of the porous bodies obtained in Production Examples 1 to 4 is shown in Table 1.

TABLE 1

| | Kind of porous body | Composition |
|---|---|---|
| Production | Aluminum alloy porous body | Al • Al₄C₃ |
| Example 1 | | |
| Production | Aluminum porous body | Al |
| Example 2 | | |
| Production | Copper alloy porous body | Cu • Ni |
| Example 3 | | |
| Production | Copper porous body | Cu |
| Example 4 | | |

### Production Example 5

### Production of Positive Electrode 1

Lithium cobalt oxide powder (average particle diameter: 5 μm) was used as a positive electrode active material. Lithium cobalt oxide powder (positive electrode active material), Li₂S—P₂S₂ (solid electrolyte), acetylene black (conduction aid) and PVDF (binder) were mixed so as to have the mass ratio (positive electrode active material/solid electrolyte/conduction aid/binder) of 55/35/5/5. To the resulting mixture, N-methyl-2-pyrrolidone (organic solvent) was added dropwise. The resultant was mixed to give a paste of positive electrode mixture slurry. Next, by feeding the resulting positive electrode mixture slurry onto the surface of “aluminum alloy porous body”, applying a load of 5 kg/cm² and pressing with a roller, pores of “aluminum alloy porous body” were filled with the positive electrode mixture. Thereafter, “aluminum alloy porous body” filled with the positive electrode mixture was dried at 100° C. for 40 minutes and the organic solvent was removed to give “positive electrode 1”.

### Production Example 6

### Production of Positive Electrode 2

The same procedure as that in Production Example 5 was performed to give “positive electrode 2” except that “aluminum porous body” was used in place of “aluminum alloy porous body” in Production Example 5.

### Production Example 7

### Production of Negative Electrode 1

Lithium titanium oxide powder (2 μm in average particle diameter) was used as a negative electrode active material Lithium titanium oxide powder (negative electrode active material), Li₂S—P₂S₂ (solid electrolyte), acetylene black (conduction aid) and PVDF (binder) were mixed so as to have the mass ratio (negative electrode active material/solid electrolyte/conduction aid/binder) of 50/40/5/5. To the resulting mixture, N-methyl-2-pyrrolidone (organic solvent) was added dropwise. The resultant was mixed to give a paste of negative electrode mixture slurry. Next, by feeding the resulting negative electrode mixture slurry onto the surface of “copper alloy porous body”, applying a load of 5 kg/cm² and pressing with a roller, pores of “copper alloy porous body” were filled with the negative electrode mixture. Thereafter, “copper alloy porous body” was dried at 100° C. for 40 minutes and the organic solvent was removed to give “negative electrode 1”.

### Production Example 8

### Production of Negative Electrode 2

The same procedure as that in Production Example 7 was performed to give “negative electrode 2” except that “copper porous body” was used in place of “copper alloy porous body” in Production Example 7.

### Production Example 9

### Production of Solid Electrolyte Membrane 1

Li₂S—P₂S₂ (solid electrolyte), as a lithium ion conductive glass-like solid electrolyte, was ground into a size of 100 mesh or less in a mortar and pressure-molded into a disk-like shape with a diameter of 10 mm and a thickness of 1.0 mm to give “solid electrolyte membrane 1”.

### Example 1

The “solid electrolyte membrane 1” was sandwiched between “positive electrode 1” and “negative electrode 1”. Thereafter, the resulting product was subjected to pressure joining to give “all-solid lithium secondary battery 1”.

### Comparative Example 1

The same procedure as that in Example 1 was performed to give “all-solid lithium secondary battery 2” except that “positive electrode 2” was used in place of “positive electrode 1” and “negative electrode 2” was used in place of “negative electrode 1” in Example 1.

### Experimental Example 1

Each of the all-solid lithium secondary batteries obtained in Example 1 and Comparative Example 1 was evaluated for the discharge capacity retention ratio at the 100th cycle by performing a charge-discharge cycle test at a current density of 100 μA/cm². The results are shown in Table 2.

TABLE 2

| | | Positive electrode | | | Negative electrode | | | Discharge |
|---|---|---|---|---|---|---|---|---|
| | | | | Young's | | | Young's | capacity retention |
| | | Positive | Porous | modulus of | Negative | Porous | modulus of | ratio at 100th |
| | Battery | electrode | body | porous body | electrode | body | porous body | cycle |
| | No. | No. | material | (GPa) | No. | material | (GPa) | (%) |
| Example 1 | All-solid | Positive | Aluminum | 81 | Negative | Copper | 160 | 97 |
| | lithium | electrode 1 | alloy | | electrode 1 | alloy | | |
| | secondary | | | | | | | |
| | battery 1 | | | | | | | |
| Comparative | All-solid | Positive | Aluminum | 65 | Negative | Copper | 115 | 89 |
| Example 1 | lithium | electrode 2 | | | electrode 2 | | | |
| | secondary | | | | | | | |
| | battery 2 | | | | | | | |

The results shown in Table 2 reveal that the all-solid lithium secondary battery of the present invention is satisfactory in cycle characteristics.

### INDUSTRIAL APPLICABILITY

The all-solid lithium secondary battery of the present invention can be suitably used as an electric power supply for mobile electronic equipment such as a mobile phone and a smartphone and for an electric vehicle, a hybrid electric vehicle or the like which uses a motor as a power source.

### REFERENCE SIGNS LIST

1: Positive electrode
2: Negative electrode
3: Ion conductive layer
4: Electrode laminate
5: Positive electrode active material powder
6: Conductive powder
7: Current collector of positive electrode
8: Negative electrode active material powder
9: Current collector of negative electrode
10: All-solid secondary battery
60: All-solid secondary battery
61: Positive electrode
62: Negative electrode
63: Solid electrolyte layer (SE layer)
64: Positive electrode layer (positive electrode body)
65: Current collector of positive electrode
66: Negative electrode layer
67: Current collector of negative electrode

1. An all-solid lithium secondary battery comprising a positive electrode and a negative electrode, each of the electrode being an electrode in which a three-dimensional network porous body is used as a current collector and pores of the three-dimensional network porous body are filled with at least an active material, wherein the three-dimensional network porous body of the positive electrode comprises an aluminum alloy with a Young's modulus of 70 GPa or higher and the three-dimensional network porous body of the negative electrode comprises a copper alloy with a Young's modulus of 120 GPa or higher.

2. The all-solid lithium secondary battery according to claim 1,
wherein the active material of the positive electrode is at least one selected from the group consisting of lithium cobalt oxide (LiCoO₂), lithium nickel oxide (LiNiO₂), lithium cobalt nickel oxide (LiCoₓNi₁₋ₓO₂; 0<x<1), lithium manganese oxide (LiMn₂O₄) and lithium manganese oxide compound (LiM_{y}Mn_{2-y}O₄; M=Cr, Co or Ni, 0<y<1), and
wherein the active material of the negative electrode is graphite, lithium titanium oxide (Li₄Ti₅O₁₂), a metal selected from the group consisting of Li, In, Al, Si, Sn, Mg and Ca, or an alloy containing at least one of the metals.

3. The all-solid lithium secondary battery according to claim 1, comprising the positive electrode, the negative electrode, and a solid electrolyte layer sandwiched between the positive electrode and the negative electrode.

4. The all-solid lithium secondary battery according to claim 3, wherein the pores of the three-dimensional network porous body are filled with a solid electrolyte, and each of the solid electrolyte and a solid electrolyte forming the solid electrolyte layer is a sulfide solid electrolyte containing lithium, phosphorus and sulfur as constituent elements.
